(19) United States
(12) Patent Application Publication
(10) Pub. No.: US 2006/0165884 A1
(43) Pub. Date: Jul. 27, 2006

(54) Increasing fiber volume and/or uniformity in an ultrasonically consolidated fiber reinforced metal-matrix composite

(76) Inventors: Dawn White, Ann Arbor, MI (US); Grant K. Martin, Ann Arbor, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/311,019

(22) Filed: Dec. 19, 2005

Related U.S. Application Data
(60) Provisional application No. 60/637,233, filed on Dec. 17, 2004.

(51) Int. Cl. B05D 1/12; B05D 1/36; B06B 1/00; B05D 7/00

(52) U.S. Cl. 427/180; 427/402; 427/600

(57) ABSTRACT

Methods of fabricating a metal-matrix composite materials comprise the steps of providing a plurality of fibers, providing a plurality of metal wires, positioning the wires and fibers in alternating fashion on a substrate, covering the wires and fibers with a layer of metal to create a multi-layer composite, and ultrasonically consolidating the composite. Titanium, aluminum and alloys and other metals are applicable to the process. The fibers may be boron, silicon carbide, glass, alumina and other common reinforcements or, alternatively, optical fibers, shape-memory fibers, piezo-ceramic fibers may be used. The fibers or the wires may be of uniform or varying composition, and may b are applied to a working surface separately or simultaneously, in which case they may be collimated and delivered to a working surface in aligned fashion.

### REFERENCE TO RELATED APPLICATION

This application claims priority from U.S. Provisional Patent Application Ser. No. 60/637,233, filed Dec. 17, 2004, the entire content of which is incorporated herein by reference.

### FIELD OF THE INVENTION

This invention relates generally to additive manufacturing and, in particular, to ultrasonically consolidated metal-matrix composite materials.

### BACKGROUND OF THE INVENTION

Ultrasonic consolidation is an additive manufacturing technology used to produce objects of any geometry from uniform, featureless feedstocks, such as tapes, sheets, wires, or droplets. There are a range of methods for accomplishing the metallurgical consolidation of the feedstocks via ultrasonic energy. These include, but are not limited to, spot consolidation, continuous rotary consolidation, plate-type consolidation, and so forth.

My U.S. Pat. No. 6,519,500, the entire content of which is incorporated herein by reference, is directed to a system and a method of fabricating an object by adding material layers incrementally and consolidating the layers through the use of ultrasonic vibrations and pressure. The layers are placed in position to shape the object by a material feeding unit. The raw material may be provided in various forms, including flat sheets, segments of tape, strands of filament or single dots cut from a wire roll. The material may be metallic or plastic, and its composition may vary discontinuously or gradually from one layer to the next, creating a region of functionally gradient material. Plastic or metal matrix composite material feedstocks incorporating reinforcement materials of various compositions and geometries may also be used.

If excess material is applied due to the feedstock geometry employed, such material may be removed after each layer is bonded, or at the end of the process; that is, after sufficient material has been consolidated to realize the final object. A variety of tools may be used for material removal, depending on composition and the target application, including knives, drilling or milling machines, laser cutting beams, or ultrasonic cutting tools.

The consolidation is effected by ultrasonic welding equipment, which includes an ultrasonic generator, a transducer, a booster and a head unit, also called a horn or sonotrode. Ultrasonic vibrations are transmitted through the sonotrode to the common contact surface between two or more adjacent layers, which may include layers next to each other on the same plane, and/or layers stacked on top of each other. The orientation of the sonotrode is preferably adjusted so that the direction of the ultrasonic vibrations is normal to the contact surface when consolidating layers of plastic material, and parallel to the contact surface when consolidating layers of metal.

The layers are fed sequentially and additively according to a layer-by-layer computer model description of the object, which is generated by a computer-aided design (CAD) system. The CAD system, which holds the layered description of the object, interfaces with a numerical controller, which in turn controls one or more actuators. The actuators impart motion in multiple directions, preferably three orthogonal directions, so that each layer of material is accurately placed in position and clamped under pressure. The actuators also guide the motion of the sonotrode, so that ultrasonic vibrations are transmitted in the direction required through the common contact surfaces of the layers undergoing consolidation.

According to my issued U.S. Pat. No. 6,685,365, the entire content of which is incorporated herein by reference, a continuous, single-step, low-temperature process combines metal coating with the splicing of fibers, producing a single, continuous low-cost process for embedding fibers in metal, and/or the splicing of fibers with a joint featuring uniform composition and high strength requiring no additional adhesives. The method can be used to create terminations for cables, or it can be used as a method of splicing or joining optical fibers by positioning the ends of the two fibers under the foils, so that they abut prior to creating the bond. The consolidation material may be provided in sheets, with or without fiber-locating grooves or, alternatively, droplets may be used. In the preferred embodiment, ultrasonic vibrations are used as the source of consolidation energy. A range of metals are suited to the process, including aluminum, copper, titanium, nickel, iron and their alloys as well a numerous other metals of more limited structural utility.

Metal-Matrix Composites (MMCs) provide unique structural advantages over conventional materials. While the matrix material retains the benefits of many metals, namely, high melting temperature, ductility and strength, continuous reinforcing fibers can bolster these properties typically providing significant increases in stiffness. In this way, materials such as SiC or boron-reinforced aluminum structures can address many design problems that face industry today.

Though the virtues of MMCs are many, their major drawback is that they are exceptionally difficult to fabricate. Embedding any material inside of a metal matrix can be complicated, but these problems are amplified by the limited capability of metal joining technologies and stringent performance requirements. Typically, processes such as metal spraying, hot isostatic pressing, etc. are used to produce continuous fiber MMCs in multi-step, very costly processes with high scrap rates. This has slowed the adoption of MMCs in structural applications such as airframes, satellites, etc.

### SUMMARY OF THE INVENTION

This invention relates to methods of fabricating a metal-matrix composite materials using ultrasonic consolidation. In the preferred embodiment, the method comprises the steps of providing a plurality of fibers, providing a plurality of metal wires, positioning the wires and fibers in alternating fashion on a substrate, covering the wires and fibers with a layer of metal to create a multi-layer composite, and ultrasonically consolidating the composite. Titanium, aluminum and alloys and other metals are applicable to the process. The fibers may be boron, silicon carbide, glass, alumina and other common reinforcements or, alternatively, optical fibers, shape-memory fibers, piezo-ceramic fibers may be used. The fibers or the wires may be of uniform or varying composition, and may b are applied to a working surface separately or simultaneously, in which case they may be collimated and delivered to a working surface in aligned fashion.

### BRIEF DESCRIPTION OF THE INVENTION

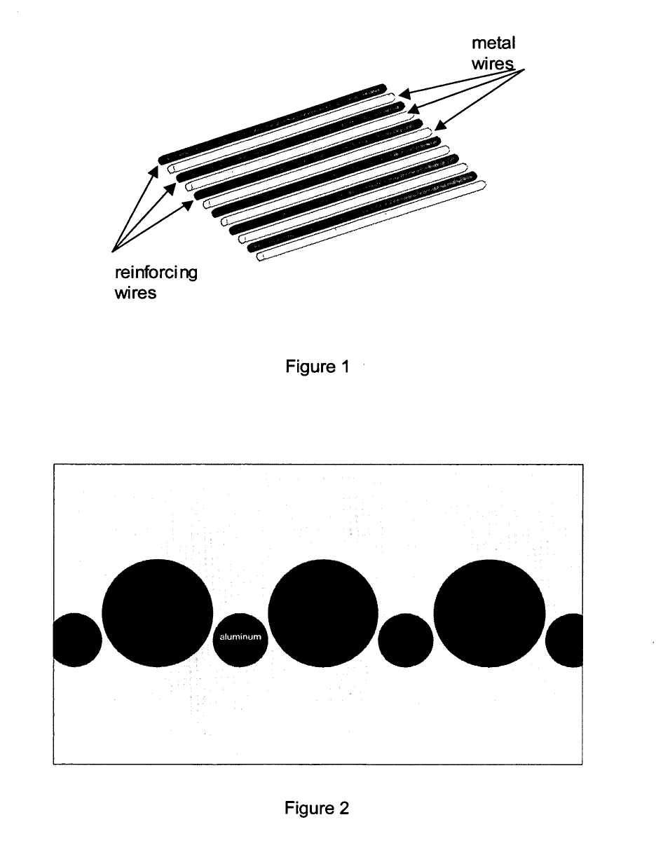

FIG. 1 is a perspective drawing illustrating metal wires interspersed between reinforcing wires in accordance with the invention; and

FIG. 2 is a cross section showing smaller-diameter aluminum wires disposed between larger reinforcing wires.

### DETAILED DESCRIPTION OF THE INVENTION

This invention resides in apparatus and methods for embedding continuous fibers such boron, silicon carbide, glass, alumina and other common reinforcements in a metal matrix. FIG. 1 is a perspective drawing illustrating metal wires interspersed between reinforcing wires in accordance with the invention, and FIG. 2 is a cross section showing smaller-diameter aluminum wires disposed between larger reinforcing wires.

Although titanium and aluminum and alloys thereof are the two most common matrix materials for continuously reinforced MMCs, other metals could be used with the methods described here. The processes result in improved techniques for embedding reinforcing fibers, as well as optical fibers, shape-memory fibers, piezo-ceramic fibers, etc., using ultrasonic consolidation. Under ultrasonic excitation, the surrounding metal matrix plastically flows around the reinforcement, encapsulating the fibers and creating a true metallurgical bond around them.

The direct approach of simply laying fibers between metal foil layers works well with small numbers of fibers and relatively wide fiber spacing. However, as the width of the reinforcing fibers and the number of ends per unit length increases, the difficulty of ensuring uniform flow of the metal matrix around the fibers increases substantially. Since higher fiber volumes are desirable, it is important to overcome this difficulty.

One way to promote better plastic flow is to incorporate interstitial aluminum or other metallic fibers between the reinforcing fibers, thus providing additional material to fill any gaps between each filament. This fiber adds a negligible weight percent to the surrounding matrix but dramatically increases the weldability of the system. These weld-assist fibers may be of any size or shape, as they primarily serve the purpose of holding the boron or other materials in place to promote plastic flow throughout the system.

The metal wires typically have the same composition as the rest of the matrix metal, although other compositions are possible. The metal wires can be round, or have some other cross section that may prove to be convenient, for example, oval, square or rectangular. The heat treatment of these wires can be the same as, or different from, the rest of the matrix. The wires and fibers may be applied to a working surface separately or simultaneously, in which case they may be collimated and delivered to a working surface in aligned fashion.

We claim:

1. A method of fabricating a metal-matrix composite material, comprising the steps of:
providing a plurality of fibers;
providing a plurality of metal wires;
positioning the wires and fibers in alternating fashion on a substrate;
covering the wires and fibers with a layer of metal to create a multi-layer composite; and
ultrasonically consolidating the composite.

2. The method of claim 1, wherein the metal wires are aluminum or an alloy thereof.

3. The method of claim 1, wherein the metal wires are titanium or an alloy thereof.

4. The method of claim 1, wherein the metal wires are round in cross-section.

5. The method of claim 1, wherein the metal wires are oval in cross-section.

6. The method of claim 1, wherein the metal wires are rectangular in cross-section.

7. The method of claim 1, wherein the metal wires are rectangular in cross-section.

8. The method of claim 1, wherein the fibers are reinforcing fibers.

9. The method of claim 1, wherein the fibers are boron.

10. The method of claim 1, wherein the fibers are silicon carbide.

11. The method of claim 1, wherein the fibers are glass.

12. The method of claim 1, wherein the fibers are alumina.

13. The method of claim 1, wherein the fibers are optical fibers.

14. The method of claim 1, wherein the fibers are shape-memory fibers.

15. The method of claim 1, wherein the fibers are piezo-ceramic fibers.

16. The method of claim 1, wherein the fibers or the wires are of uniform or varying composition or cross-section.

17. The method of claim 1, wherein the fibers and the wires are applied to a working surface separately or simultaneously.

18. The method of claim 1, wherein the fibers and the wires are collimated and delivered to a working surface in aligned fashion.

19. The method of claim 1, wherein the wires are heat-treated prior to consolidation.

20. A metal-matrix composite material fabricated in accordance with the method of claim 1.
